(19) United States
(12) Patent Application Publication
(10) Pub. No.: US 2006/0143220 A1
(43) Pub. Date: Jun. 29, 2006

(54) Software application framework using meta-data defined object definitions

(76) Inventor: Herman Spencer JR., Plano, TX (US)

Correspondence Address: VIERRA MAGEN MARCUS & DENIRO LLP, 575 MARKET STREET SUITE 2500, SAN FRANCISCO, CA, 94105, US

(21) Appl. No.: 11/028,473

(22) Filed: Jan. 3, 2005

Related U.S. Application Data
(60) Provisional application No. 60/534,093, filed on Dec. 31, 2003.

(51) Int. Cl. G06F 17/30

(52) U.S. Cl. 707/102

(57) ABSTRACT

An application framework for creating business process management software applications. The framework includes a data store including application data and information describing said data for a runtime environment. The information describing the application data includes presentation information and relational information. The framework further includes presentation logic outputting said data based on said information describing said data, and one or more automated business processes operable on said data.

### BACKGROUND OF THE INVENTION

1. Field of the Invention

The present invention is directed to customizable software used to perform myriad tasks, and in particular, a software environment using data objects defined by meta-data definitions to enable business process applications.

2. Description of the Related Art

Databases contain aggregations of data records or files which can be used by applications to present information to users. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Typically, a database manager provides users the capabilities of controlling read/write access, specifying report generation, and analyzing usage. Databases and database managers are prevalent in large mainframe systems, but are also present in smaller distributed workstation and mid-range systems.

Application developers generally construct their applications to access data using one or more conventional mechanisms to retrieve and present data. This is a structured approach, and makes providing different types of applications, and different types of data or data hierarchies, rather rigid. This type of system also makes it difficult to configure applications to use data structures which are not defined in the underlying structure.

Users would benefit from a more flexible approach to application development using more flexibly defined application data. Such a system can form the basis for multiple types of application development.

### SUMMARY OF THE INVENTION

The present invention, roughly described, pertains to a business application development environment. The environment comprises a series of functional components interacting with data provided in a self-described data model environment. This invention provides a business application software system wherein all underlying data is defined by meta-data, and application code is executed against data stored in objects defined by this meta-data.

An application framework for creating business process management software applications. The framework includes a data store including application data and information describing said data for a runtime environment. The information describing the application data includes presentation information and relational information. The framework further includes presentation logic outputting said data based on said information describing said data, and one or more automated business processes operable on said data

In another embodiment, the invention is a software application. The application includes a plurality of business resources defined by data, and meta data contained in a data dictionary. Application code, operable on said business resources to implement at least one business process and provide an output to a user, is included with in this embodiment.

In yet another embodiment, the invention is an application framework. The framework include: a presentation runtime; a data store including application data objects and information describing said application data objects for a runtime environment; process automation code operable on said data objects implementing business processes; and a state management engine.

In still another embodiment, the invention is a business process automation system. The system includes a plurality of smart data objects, the data objects including a value and information about the data objects relationship to other objects, the plurality of objects defining a set of business resources, and an application presentation system, including code interpreting input to and output from the smart objects.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

The invention will be described with respect to the particular embodiments thereof. Other objects, features, and advantages of the invention will become apparent with reference to the specification and drawings in which:

FIG. 1 depicts a block level diagram of hardware system for implementing the present invention.

FIG. 2 is a block diagram of a computer suitable for use as a process or application server, or a user 10 terminal, in accordance with the present invention.

FIG. 3 depicts a run-time environment of components and services in an application system designed to provide a facilities management system.

FIG. 4 is a block diagram showing code interaction hierarchy between user level input/output and a data level environment.

FIG. 5 depicts an entity relationship diagram of a data dictionary suitable for use in accordance with the present invention.

FIG. 6 depicts an entity relationship diagram of smart objects utilized in accordance with the present invention.

FIG. 7 depicts an entity relationship diagram of an application layout utilized in accordance with one embodiment of the present invention.

FIG. 8 is an example of a portal screen utilizes in accordance with the present invention.

### DETAILED DESCRIPTION

The system of the present invention provides a mechanism for building application programs, and in particular business management and process applications, using a data structure which defines all elements in the system using meta-data. In one aspect, this meta-data is provided in a self-defined data dictionary. This means that all data elements in the system can be understood with reference to their dictionary definition, and code implementing application level functions need only understand how to understand the definitions of the object to understand how to manipulate the objects to accomplish their function.

In one embodiment, the system can implement a number of types of applications. For convenience, the system will be described herein with respect to a facilities management application with functionality designed to manipulate a business facility, and associated employees and resources in that facility. It should be understood that the system can be utilized to develop any number of process or sequence oriented application, or other types of applications. In addition, the invention will be described with respect to its use with a self-defined data model consisting of a series of tables. However, it should be understood that other data structures, aside from tables commonly used in the relational database model, may be utilized in accordance with the present invention.

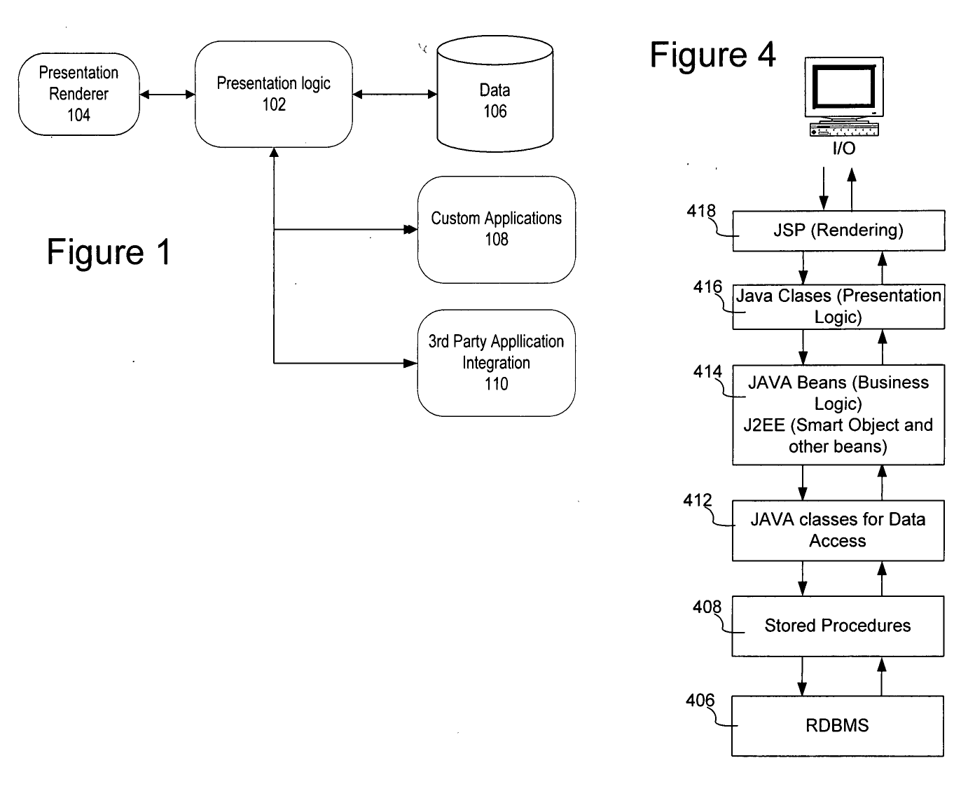

FIG. 1 is a block diagram showing an overview of major components of a system of the present invention which implements a business application. FIG. 1 shows presentation logic 102, which in this embodiment comprises a series of Java classes and Java Server Pages (JSP), which integrates user data 106, custom applications 108, and third-party applications 110 to provide an application on a presentation rendering environment 104. The presentation renderer can be any user device such as a personal computer, mobile device, or internet terminal running an interpretive virtual machine, or simply a web-browser. Alternatively, the renderer can be a third party application such as Microsoft Corporation's Word or Excel, or Crystal Reports by Crystal Decisions, Inc., Palo Alto, Calif. The elements shown in FIG. 1 may be provided on a single processing device or as shown below, multiple processing devices.

In the context of the present invention, the data is defined using a self-defined data model which allows a finite number of structural entities to define all data and objects within the application environment. Custom applications 108 may comprise task-specific applications, such as business logic applications, facilities management applications, and project applications, which use the data in data store 106 and that provided by 3^{rd} party application integration 110 to provide functionality via the presentation logic 102. Third-party application integration 110 includes modules allowing the custom applications 108 and presentation logic 102 to assess data stored in other formats—for example, relational databases or object databases, which are provided by third-parties or which may have been utilized by application users prior to integration with the system of the present invention.

In one embodiment, a facilities management application may be implemented by the application platform as a web-based system that addresses all design and operational processes related to real estate, operations & maintenance, and facilities management, including aspects from space planning and project management, through maintenance and operations, to transaction management and lease administration. In a facilities management application, for example, a workflow engine allows users to establish and implement customized workflow processes that mirrors existing approval, action, distribution, and routing processes. The application may provide reporting functionality, allowing a user to: filter, search, sort, and view data; generate dynamic reports that reflect exact information needs and data specifications; create tabular, summary, matrix, or form style reports; tailor the look and feel of the reports, as well as how they are grouped, ordered, and summarized; and integrate with third party reporting tools for analytical reporting.

The application may include a portfolio management serving as a central hub for all events, processes, information, costs, and communication related to facilities and the assets, people, and organizations they hold. The component can track the skills and certifications, regulatory information, financial data (i.e., cost centers, depreciation, and charge accounts), warranties, contracts, and associated items for each record, as well as all fields created by the user. In addition, all items created within the component can be defined as “schedulable.” With this functionality, each time a user views an item they will be presented with a calendar and the ability to schedule or reserve that item for one-time or recurring events. Each record created—each person, location, asset, geography, specification or organization defined—can be assigned to a specific place in a hierarchy and can be associated with any other defined items. Alarms and notifications can be associated with each record to trigger messages at predetermined times or in conjunction with scheduled events. All lifecycle events associated with a record are tracked, creating a complete history and providing real-time status.

A space planning component may be included to allow facility managers to track and maintain utilization, density, vacancy rates, security, and proximity information while providing links to CAD drawings so that relationships can be readily visualized and managed in the most effective way.

Space allocation information may also be used to create graphical, color-coded stack diagrams to represent floor-by-floor organizational layouts within a building or among the buildings on a property. This information can be used to perform space audits -- point-in-time snapshots that show the historical use of space. By specifying a time frame, a user can audit buildings and floors to create a log that displays allocation details, such as key allocation area and cost; a headcount summary, including total headcount, cost and area per person. Tools for move management, additions, or changes of personnel, assets, resources, and organizations can also be provided.

A contract manager component enables accurate, detailed tracking and management of any type of contracts, from real estate leases through purchase orders to service level agreements. The contract manager component allows users to track and manage any type of contracts. Functionality might include the ability to centrally store and track all contract documentation and information, including associated assets, critical dates and actions, financial transactions, options, conditions, and clauses. Such a system might need to integrate with legacy fixed asset accounting and corporate financial ERP systems already in use by the users.

A call center component provides help desks with a centralized location for managing demand service orders and requests received from web, phone, email, handheld, or fax sources employees can be provided with a self service option to enable users to quickly and easily find and request the assets, services, locations, or personnel they need without third party support or intervention.

A resource reservation component that may provide users with the ability to reserve ‘common use’ resources (such as locations, assets, and people). A resource locator enables employees to easily find the locations, assets, and people they need. The facilities application may utilize messaging functionality, allowing users to create, send, and receive communication and information, such as meeting reminders to work orders. Hyperlinks can allow users to click directly to the document, event, or record referenced within a message.

A financial manager component provides a way to keep on top of budgetary issues that affect operations, such as tracking budgets, allocations, contract payments, project expenditures, work order charges, receipts, and other cost-related items. Such items might further be associated with the appropriate budget centers, cost centers, charge accounts, and budget lines.

A space planning manager component can track and maintain utilization, density, vacancy, security, and proximity information. It can manage the movement, addition, or change of personnel, assets, resources, and organizations, and track costs associated with or estimated for a move. It can track planned maintenance for facilities by defining, implementing, and enforcing maintenance standards and best practices. In such a system, one would desire to create detailed cost plans based on historical time and material usage, and create preventative maintenance schedules, job plans, and work orders for one time or recurring events.

A materials tracking component can track the availability and use of stored furniture, fixtures, office equipment, workstations, maintenance equipment, parts, and materials. In addition, it should be able to provide an accurate inventory and stockroom control with detailed tracking abilities. Users should be able to receive automatic notification when items reach user-defined reorder levels.

A document manager component allows users to post documents, drawings, contracts, etc. for team members to access, view, and edit. In addition, users can control which employees and business partners can view, edit, create, or delete any particular file or document set, as well as maintain document integrity through revision and versioning control.

The foregoing examples are illustrative of the type of functionality that an application built in accordance with the system of the present invention may provide.

Another exemplary use for the application platform includes a project management application providing the ability to track projects from project development through design and construction management.

A project manager component allows users to create hierarchies, set permissions, and manage documents on a project-by-project basis. In addition, users can define project specific workflows, messages, data, budgets, and interfaces.

In one embodiment, the application may be implemented as a Web-based portal which provides access to all information needed to accomplish tasks, determine the overall stability of cost and time performance, and assess the need for corrective actions. The underlying application development system described herein allows individual organizations can create project wizards to establish their own delivery methods for different projects, and further allows users to define ‘templates’ for various project categories and sizes, taking a structured and repeatable approach to all projects regardless of size. The application framework allows users to define, structure, and coordinate multiple projects at a program level. In one embodiment, a System Administrator can provide templates that allow users to develop a program by establishing a business case, cost vs. benefits analysis, the risks or potential escalation of issues based on historical performance, contingencies, resource allocations, and scheduled milestones for success.

One component of a project management application can include a project Cost Management function. Cost Management serves as a centralized collection point for all transactional events that impact costs. It allows users to monitor estimates, cash flow and budgets, track the status of commitments, manage timesheets, track and allocate funding as well as view liabilities throughout the project's lifecycle.

Another component can include integrated schedule and resource management supporting the traditional critical path definition with Gantt chart output for easy review and linking an event in any process to a task and activity definition in order to spawn system intelligence for quick execution.

Another component can comprise a change management function which facilitates quick and appropriate action on emerging concerns or problems that may adversely impact a project. It provides users with the ability to effectively document, report, elevate, track, forecast and resolve issues and/or potential changes that may impact cost, schedule, or user-defined sources. It enables users to create a defined approval process and to track status across company borders to facilitate timely action and maintain accountability on potential changes. It also enables users to link information—from support documentation to affected specifications, RFIs, or contracts—directly to change events to provide all parties with the real-time information required to make accurate decisions.

A supply chain management component can offer a centralized and complete electronic process for procurement and supply chain management that enables full electronic vendor participation. Supply chain management enables users to create, log, and track contracts, purchase orders, and other commitments. Users can log and track applications for payment, change orders, shipping notifications, invoices, and receipts against those commitments.

A design management component enables users to orchestrate, control, and track the design review process, including checklists, comments, and deliverables. By facilitating comprehensive reviews, it reduces the risk of substantial issues and changes in construction. In addition, this toolset allows users to create a dynamic relationship between an item, its attributes, and its components and maintain this relationship for the life of the asset. Users can create and reuse detailed specifications of everything from wall types to lighting fixtures.

A risk management component offers a multi-faceted approach to change monitoring, impact mitigation, and process management by identifying risk items from across the project in a single, centralized location. It uses the historical knowledgebase of past issues, variances, corrective actions, and all other lessons learned to help users gain a comprehensive understanding of project risks and enable future planning and mitigation.

A project administration component can automate and centralize the traditionally manual tasks involved in project administration. Requests For Information (RFIs), submittals, transmittals, meeting minutes, and all other areas of correspondence can all be created, tracked, and managed within Project Administration. All parties involved as well as their actions are documented for accountability. Response times and requirements are automatically tracked and monitored to help expedite critical matters.

A field management component can automate and centralize communication with field personnel, drastically reducing both paperwork and project delays. Field management allows users to create and maintain daily journals, which can be accessed in real-time by managers throughout the organization. It provides field personnel with instant access to field instructions, punch lists, and safety notices, as well as inspection and test lists—all the information needed to ensure that actual construction is performed according to all applicable standards.

In a project application, a document manager allows users to control which employees and business partners will have permission to view, edit, create, or delete any particular file or document set, and includes optional desktop integration capabilities. The document manager provides revision and versioning control to maintain document integrity and create a comprehensive document history and audit trail. Documents can be checked in and out by authorized users and comments, notes, and threaded discussions can be attached to all documents. All of the documents related to a project can now be contained, searched, and accessed in a single electronic data repository, making data warehouses and lost files obsolete. Search and filtering capabilities allow users to quickly find the specific piece of data or document they need.

The Business Object Editor provides control over application screens and the way in which users navigate through them, an action traditionally controlled by programmers through application code. The Business Object Editor is used to create and modify the Tabs and Sections used to organize information, as well as to manage the appearance and actions of data fields. Users can create and position a field for any piece of information and then track, manage, and report that information throughout the lifecycle. The relationships that a type of object has with other objects throughout the system can be defined via the Business Object Editor, as can hierarchical structures. The Business Object Editor is template driven, making it simple to use. No special programming skills or extensive consulting services required.

A workflow engine in the project manager enables companies to easily establish and implement customized workflow processes that mirror existing approval, action, distribution, and routing processes. The workflow for virtually any business process can be defined and can flow across projects, department, organization, and application boundaries.

To create a workflow, users simply drag and drop icons representing different user, system, approval, or message tasks. Each task can be assigned to either a specific individual or to a group of users. Workflow tasks can be routed to internal employees, as well as external consultants and service providers, creating an integrated, collaborative work environment to support concurrent operations.

A workflow can be set into action manually or automatically triggered at a certain time, after a certain event has occurred, or by any number of other user-defined parameters. Workflows can be created for both core, repetitive tasks (tasks that are performed in virtually the same way and order for every project) and unique, project-specific tasks (those tasks that are dependent on the nature of the project).

An administrator console can provide access to the application platform allowing system administrators to support, maintain and control the system. An administrator console captures all system information in one place, providing information overview and accessibility. System data, such as CPU utilization, available memory, build number and client info as well as database and network connections are presented at a glance, providing the ability to drill into more detailed data, for instance in the System, Java™, Database, and Work Flow Managers.

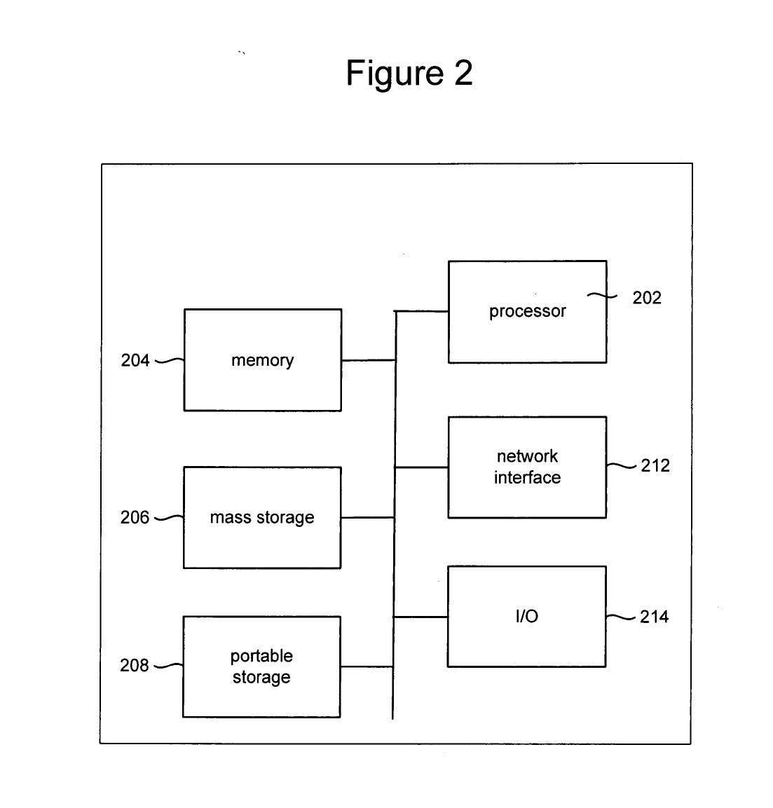

FIG. 2 shows one example of a hardware architecture for computers used to implement the present invention. The hardware includes a processor 202, a memory 204, a mass storage device 206, a portable storage device 208, a network interface 212 and I/O devices 214. The choice of processor is not critical as long as a suitable processor with sufficient speed is chosen. Memory 204 can be any conventional computer memory. Mass storage device 206 can include a hard drive, CD-ROM or any other mass storage device. Portable storage 208 can include a floppy disk drive or other portable storage device. The computer may include one or more network interfaces. The network interface can include a network card for connecting to an Ethernet or other type of LAN. In addition, one or more of the network interfaces can include or be connected to a firewall. One of the network interfaces will typically be connected to the Internet or a LAN. I/O devices 214 can include one or more of the following: keyboard, mouse, monitor, display, printer etc. Software used to perform the methods of the present invention are likely to be stored in mass storage 206 (or any form of non-volatile memory), a portable storage media (e.g. floppy disk or tape) and/or, at some point, in memory 204. Various embodiments, versions, and modification of the system of FIG. 2 can be used to implement the present invention, and the above described hardware architecture is just one suitable example depicted in a generalized and simplified form. The present invention could include dedicated hardware, a firmware to implement the invention or other software and/or hardware architectures that are suitable.

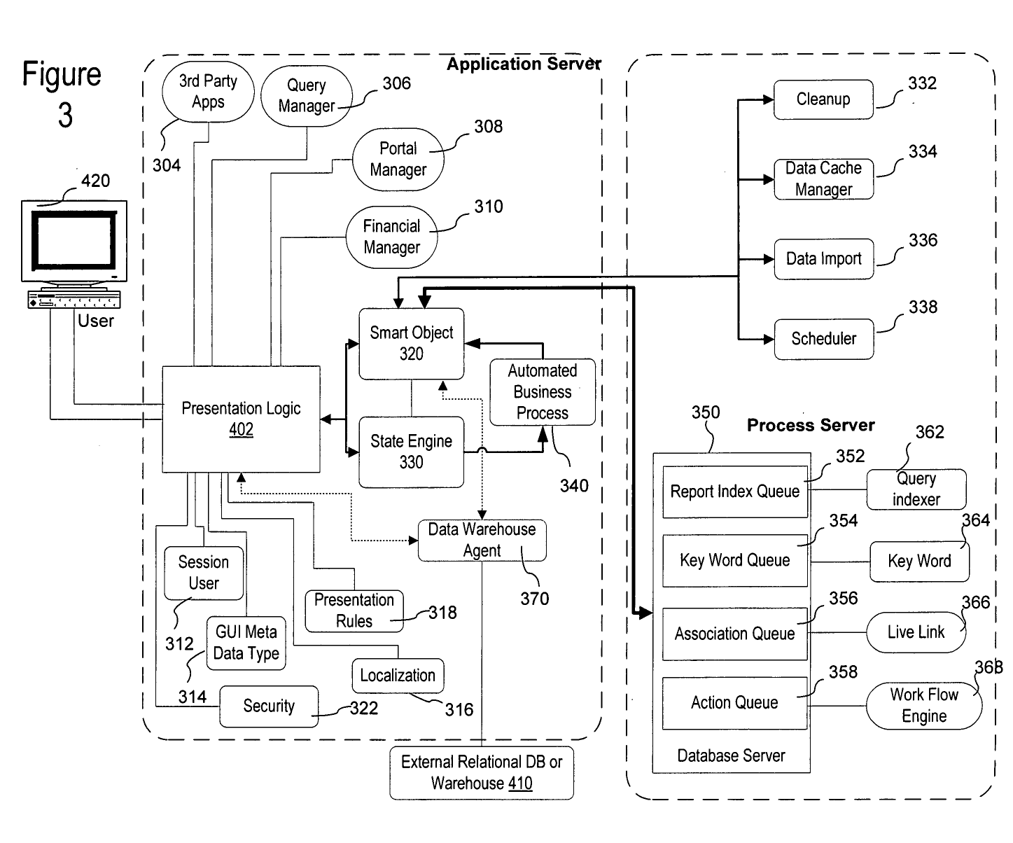

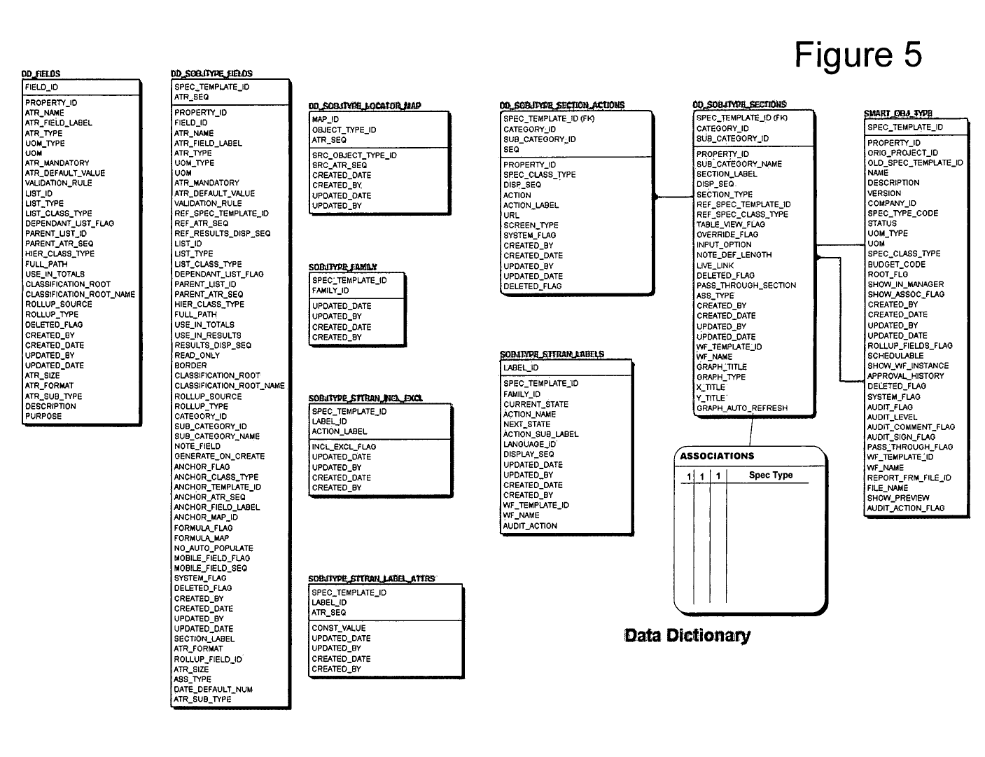

FIG. 3 illustrates the runtime environment of a facilities management application implementing the aforementioned functionality. FIG. 4 illustrates a code-level hierarchy between the user and the data levels useful for understanding how components in FIG. 3 are constructed. FIGS. 5 through 7 are entity relationship diagrams showing one embodiment for implementing the data in datastore 106. While this embodiment is described with respect to relational tables, it will be understood that any data structure which uses a self-defined data model to allow application code to access data in accordance with the description provided herein, is considered as being within the scope of the present invention.

As shown in FIG. 3, in one embodiment the system is implemented on two processing systems: an application server and a processing server. The application server includes presentation logic 302, a smart object process 320, state engine 330, business logic 340, and a series of java beans and applets which enable the functions of the custom application for which the system is designed. The presentation logic 302 communicates with a user device 420 to provide the application functionality to a user.

As illustrated in FIGS. 3 and 4, presentation logic 302 is comprised of a series of java classes 416 and java server pages 418. The presentation logic is a threaded series of java classes that can be accessed by the beans or java applications described herein. The pages 418 are communicated to the user device 420 via HTTP. It should be understood that alternative technologies may be utilized in accordance with the present invention, and that the implementation of the invention in Java or through using Java server pages is exemplary. For example, alternative languages such as C++ and alternative content control mechanism such as Active Server Pages may be utilized. It should be further understood that the user device 402 may be coupled by any number of communication mechanisms to the application server, including wireless and wireline networks, a combination of public and private networks such as the Internet, and other transport mechanisms, such as Bluetooth.

Returning to FIG. 3, also shown on the application server are a number of components which are implemented as Java beans and which interface with the presentation logic 402. These include the third-party integration bean 304, query manager bean 306, a portal manager bean 308, and a financial manager bean 310. Other applications are implemented in JavaScript and or java servlets and include a session user component 312, a GUI Meta Data type application 314, a presentation rule set 318, a localization component 316, and a security controller 322. A data-warehouse agent 370, the function of which is described below, may also be provided.

The process server is utilized for a number of background processes, including a cleanup process 332, a data cache manager 334, a data import manager 336, and a scheduler 338. In addition, the process server includes a database server 350 including a series of four queues—a report index queue 352, a key word queue, an association's queue 354 and an action queue 358. These queues serve as interfaces to associated processes 362 (query indexer), 364 (key word indexer), 366 (live link) and 368 (work flow engine). These queues are written to by the smart object process 320 whenever objects are updated, to allow the associated processes 362, 364, 366 and 368 to perform their functions.

All information in the system is stored using a series of smart objects. Generally, objects are items defined through its state and behavior. The state of an object is set forth via attributes of the object, which are included as data fields in the object. Each object has instance(s) and will include one or more data fields to store attributes of an object. Each data field contains attribute information defining a portion of the state of an object. The objects are created by a smart object process 320 which is implemented in Java and as shown in FIG. 4, uses Java classes for data access (412) via a set of stored procedures (410) which may talk directly to an RDBMS.

Smart Objects are objects defined in a common name space and which contain information about themselves and other object to which they relate. The construction of such objects is defined below with respect to FIGS. 5-7.

A smart object 320 exists for each item of data within the system. Each smart object contains information about itself and its relation to other objects in the system. The definition of these objects is controlled by the data dictionary as shown in FIG. 5. As such, presentation logic 402 in all processes of the application server is tied into this smart object environment. The flexibility of this model allows that users can build any number of different data types based on the way smart objects are defined.

A series of automated business processes 340 is defined and manipulates aspects of the smart object 320, under the control of a state engine 330.

Automated business processes 340 are, in the context of the present invention, business processes which are defined in code to synchronously or asynchronously automate the functions of a business. In the facilities management model, for example, an automated business process might define the type of things a new employee is considered to “own” when the new employee starts work at the company offices. For example, when a new employee starts, the company assigns the employee an office, a telephone, a computer, and other equipment. An automated business process might take as input the fact that the employee is created and automatically assigned these pieces of physical equipment to the employee. Alternatively, it may generate and instantiate other processes, such as routing payroll information, setting up an employee HR file, setting up review dates and the like.

Employees can therefore be defined as objects, and to have a life cycle and properties which are attached to the object. In the system of the present invention, users have flexibility over any object in the system because any object can be defined in any manner relative to any other object and include any number of user-defined fields. For the sake of convenience, the system will be described with reference to an “employee” object, and characteristics associated with it. However, it should be understood that any number of object types can be defined within the context of the system of the present invention.

Automated business processes 340 come in essentially two types. Asynchronous processes are those where an event triggers a process which can run in the background of a session. For example, in the above example of an employee being hired, when someone initially creates the employee object, the employee may be immediately assigned a telephone and a computer, and an asynchronous process perform this assignment and create a telephone and computer object associated with the user, without user input. It may perform more complicated tasks as well. No user intervention is required because a business process states that a user or an employee will have these elements. Each of the objects, the telephone, the employee, the desk, the employee's office, is a defined smart object.

Synchronous processes are those which occur in real time in the session that the user is running. When an employee has a review, another individual must input data into the system and indicate that the review task has been completed. The process may prompt for certain information, and provide feedback indicating that the process has been completed.

The automated business process, in conjunction with the state engine 330, continually updates the smart object to a current state relative to the defined process. The smart object data is used by the presentation logic to provide output to the user at the input/output terminal 420.

The application java beans 304, 306, 308, and 310 perform specific functions relative to the smart objects. The third-party integration bean 304, for example, includes information allowing third-party applications on the input/output terminal to access data contained in the smart objects, and the presentation logic to output data to the third-party applications using the data in the presentation logic 402.

A query manager bean 306 allows users to query data in the smart objects relative to the presentation logic scripts defined in the particular application. It also links to specific reports which are defined by the user and which may be indexed for faster presentation using a query indexer 362. Query manager 306 does not just return textual data, but may return graphic information such as drawings or intelligent business objects such as those described with respect to co-pending application serial number (TRIRG—1000US0) (which is fully incorporated herein by reference) and which are embedded in the presentation logic and output display 420. The query engine provides simple, visual way to search, view, and report information.

The financial manager 310 performs a separate set of financial transactions based on financial data that a facilities management system might need. For example, monetary conversions have a conversion rate, as well as data on both the date of the transaction and the amount converted. This data may be stored in smart objects and retrieved by the financial manager 310. When a financial transaction occurs which requires a monetary conversion, monetary conversion data can be stored along with the transaction amount at the time the transaction occurred. For example, suppose in the year 1988, a given exchange rate was utilized to convert pounds to dollars. This information can be stored along with the amount of the transaction in the smart object which can be retrieved by the financial manager 310 at a later date, and the transaction reconstructed. In this example, one needs to know not only the amount, but the exchange rates at the time the transaction occurred.

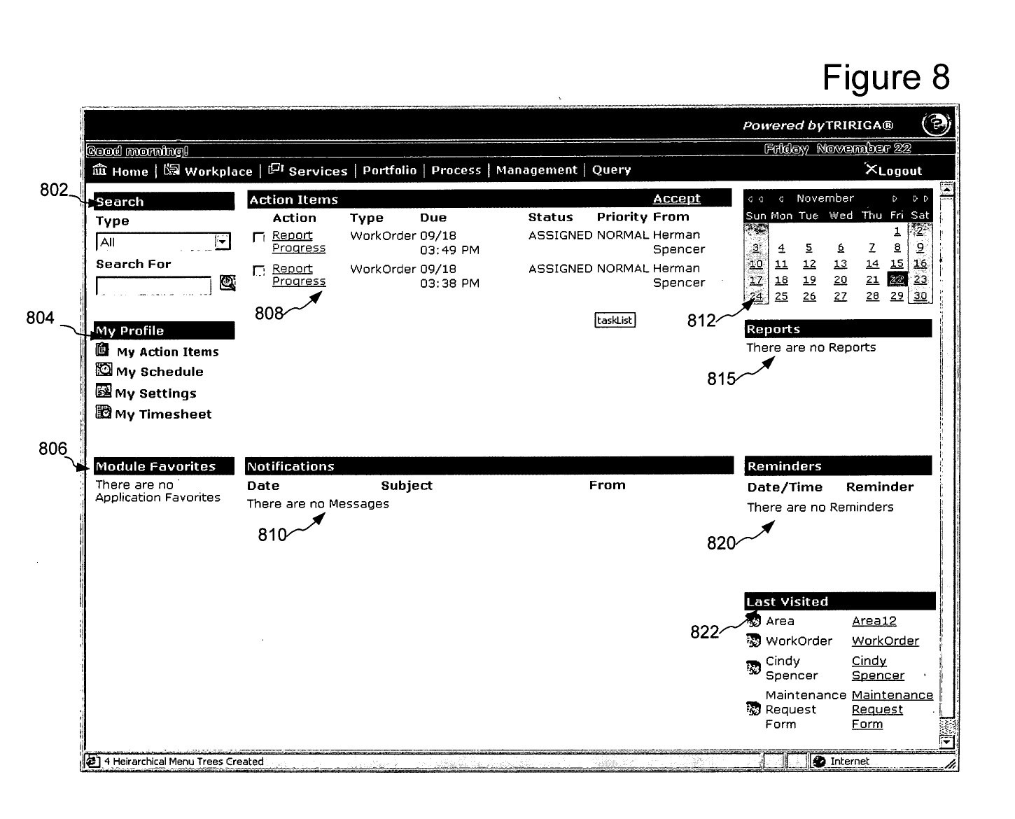

The portal manager 308 allows the user to define how the user interface in the form of an introductory web-type “portal” will appear to the user when the user enters the system. FIG. 8 is an example of the user portal for a facilities management program developed in accordance with the system of the present invention. The facilities portal in FIG. 8 includes a number of modules which are in fact data types which are presented to the presentation logic 302, and constructed as servlets for display by a browser on the user device 420. Shown in FIG. 8 are a search module 802, a profile list module 804, a favorites list module 806, action items list module 808, and a systemic notifications module 810, all of which may be generated by servlets in the system. In addition, a calendar module 812, a list of reports 815 and a list of reminders 820 and a list of recently visited links 822 are shown. Hyperlinks shown in the portal display links to queries in the query manager 306 or a report which can be generated by the presentation logic 302. The portal manager 308 allows the hyperlinks to talk to individually coded reports and to link queries from third-party applications or whatever data required from the smart objects to output to the portal display to the user.

The GUI Meta Data component 314 allows the user to define how data is presented on the user device. Interactions with smart objects are described below. The security application 322 controls levels of security for users in the system. The system may implement an administrator level and various permission levels of users, all of which are controlled by the user via the presentation renderer, presentation logic and the security component. The localization component 316 controls items such as the current currency, time, and other information on the locale of the users of the application. The presentation rules 318 comprise a set of constraints about how fields of data are presented to the user. For example, such rules include whether form fields must include data before allowing a user to progress to a next screen or process. Presentation rules can also include formatting information for items such as dates and times. The session user component 312 tracks users interacting with the system.

The state engine 330 informs automated business processes 340 where the particular events have occurred and whether to update the smart object 320. For example, if a person's salary has been adjusted, the state engine will let the business processes know to implement a synchronous salary update process which will update the data in the associated smart objects. User tools may be provided to allow the user to define the automated business processes 340.

As noted above, the smart objects 320 are at the core of the architecture shown in FIG. 3. Smart objects 320 talk to the state engine 330 to inform it whether certain events have occurred and vice versa. Smart object 320 also talks to the state engine 330 when it creates an object for the first time. An object going effectively from a state of nothing to its first state must inform the state engine that it in fact has been created. Objects may have a state life cycle. Smart object communicates two primary things outside of the data that is included with it. Smart object communicates with the database 350 and writes to four queues that are used by background applications on the process server.

In one embodiment, a warehouse agent 370 is provided to communicate with an external relational database 410. The agent 370 allows synchronization and bulk loading of a data warehouse 410. This agent is useful where users have legacy relational databases, and where access to the data in the system of the present invention is desired through the legacy system. Each time a smart object is changed, it can create a single record and the data warehouse agent will sync this record with the external database relationship at 410. If the user wishes to maintain the sync, the data warehouse agent queues the request in the warehouse agent, and when a push of data is required, the agent will push the information from the smart objects into the external data store. Syncs can be instantaneous, or at timed intervals.

The processes running on the process server essentially run on their own and are placed on the process server so that they will not interfere with the processes on the application server. Additional agents which run on the process server are garbage cleanup 332, data cache manager 334, a data import manager 336 and scheduler 338.

The garbage collector 332 gets rid of administrative physical data created when using smart object data. For example, statistics on every single event that occurs in the system may be maintained, and maintaining them for a long period creates a large volume of information. The garbage collector can clean this information up at regular or pre-determined intervals.

Scheduler 338 wakes up on regular intervals, and checks whether the user has defined any specific repeating processes that need to be performed on smart objects. If, for example, an event is scheduled to occur at 3:00 p.m. on each first Sunday of the month, the scheduling agent implements this scheduled event.

Data import agent 336 has its own queue for allowing input of third party applications in the background. For example, if user data is contained in a large spreadsheet, the import agent 336 contains extraction technology and a queue to allow the information to be converted to system data without taxing the processing resources of the application server.

The data cache manager 334 is an agent used to manipulate the cache of relational database through which the system may be controlled. In one implementation, the system is built using an underlying relational database to store the structures and data defined herein. A relational database such as that commercially available from Oracle Corporation is suitable. In such cases, the data cache manager 334 needs to make sure that the relational database keeps information in its queues so that users do not see a performance lag when non-use of the system occurs. In essence, the data cache manager is a keep alive signal to an underlying relational database system. In another implementation, an object database or proprietary data structure will be utilized. In such alternate implementations, the data cache manager 334 may not be required.

As noted above, the smart objects write to the four queues 352, 354, 356, and 358 in the database server 350 whenever an object is created, modified or deleted.

The query indexer 362 retrieves information recorded in the report index queue 352. This indexer is a special reporting index so that user queries can happen in a timely matter. With the large number of objects which are created, even key word searches can result in unacceptable performance lags when generating reports. The reports need to understand other information filters for sorting through the objects in order to present information. This index is specifically designed for report indexes which allow users to define particular reports and store critical data about that report to aid the system in retrieving report information faster.

The key word indexer 364 can read the objects, parse them and create key word indexes so that a user can search for key words and generate reports in real or near real time. The association queue communicates with the live link agent 366 which updates smart object relationships and other objects which are tied to each smart object. Object updating occurs in the background on the process server is preferable because of the volume of objects which need to be updated would be prohibited in terms of computational resources.

Finally, the action queue 358 communicates with the work flow engine 368 and actually stores the information for smart object values in the database server. Generally, the work flow agent 368 will be the most active process after the smart object process, because all applications will be utilizing this agent to write and read data from the data store.

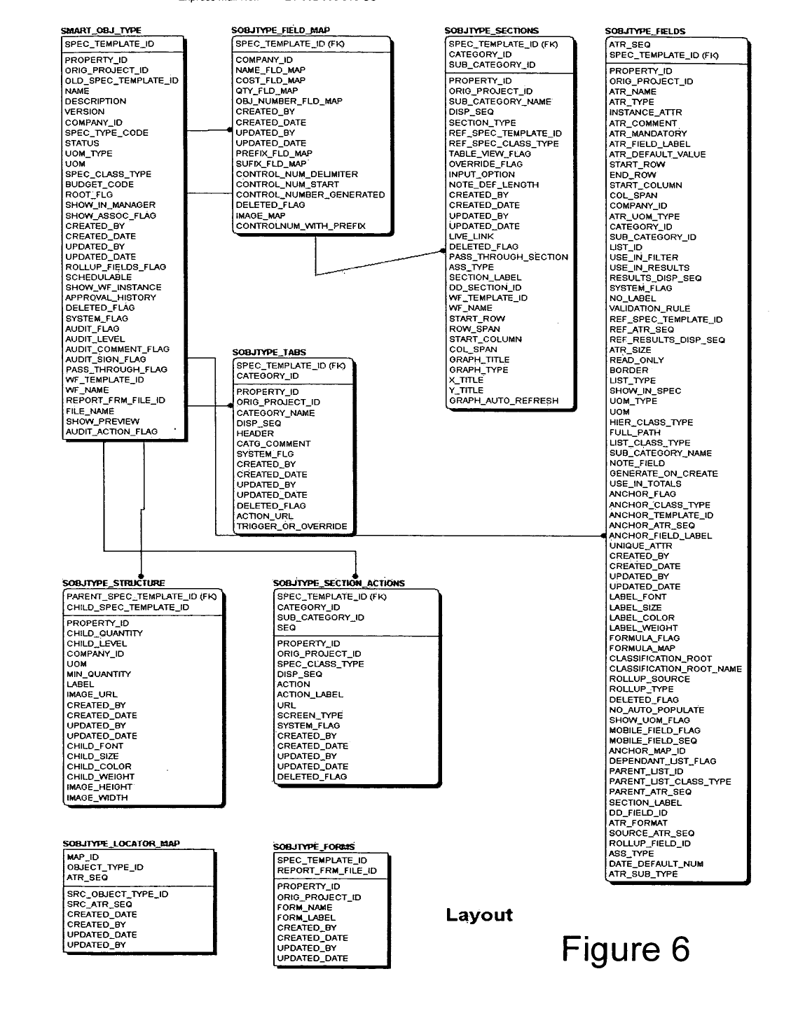

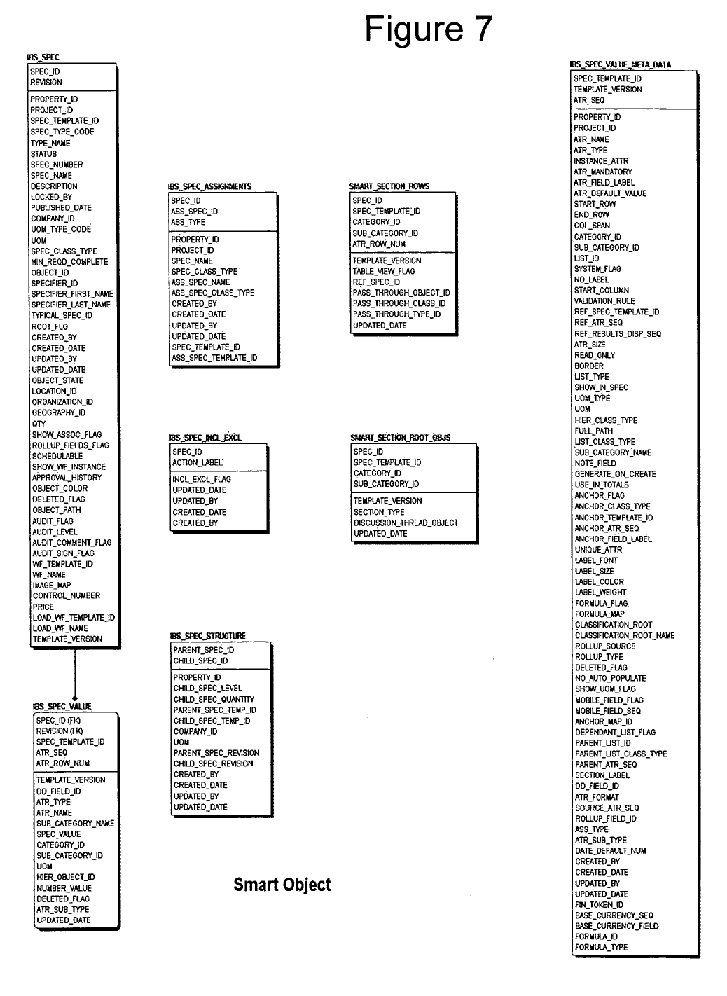

FIGS. 5-7 show an exemplary definition of a data model suitable for use with the present invention. While the above runtime environment is suitable for implementing an application based on the underlying data structure, a key component of the present invention is the organization of the data in the system. Smart objects are defined in accordance with a user defined data model. FIG. 5 shows a data dictionary defining the construction of objects in the system. The smart object structure is shown in FIG. 6, while FIG. 7 shows the structure of layout objects which are applied to the user interface.

FIG. 5 shows the data dictionary structure. This structure includes a number of tables: DD_FIELDS, DD_SOBJTYPE_FIELDS, DD_SOBJTYPE_LOCATOR_MAP, SOBJTYPE_FAMILY, SOBJTYPE-STTRAN_INCL_EXCL, DD-SOBJTYPE-SECTION-ACTIONS, DD-SOBJTYPE-SECTIONS, SMART-OBJ-TYPE, ASSOCIATIONS, SOBJTYPE_STTRN_LABELS, AND SOBJTYPE_STRAN_LABEL_ATTRS.

FIG. 5 describes one implementation of the meta-data necessary to model an object. In particular, the fields, and objects are shown, as well as fields which constitute objects, objects which constitute objects, what workflows are tied to particular objects, what associations are made from those objects in which reports are executed from, and as well as other information about objects.

It will be noted that each structure in FIG. 5 contain myriad fields. Fields which have a significant function in identifying information about the object structure or use are described herein. Other fields have pneumonic names whose function is apparent there from.

The DD_FIELDS structure provides namespace functionality for the system. For example, it includes a field for “attribute name” (ATR-NAME) which is a unique value—there can only be one for each field. Because it is unique, its ATR_TYPE is also unique—this type is just one column for this one record. All base fields and any field used with the system would have a record in this structure. For a “person object,” for example, a variable of “first name” would have a record in this table, “last name” would have a record in this table, “age” would have a record in this table, etc.

Type fields in the DD_SDOBJTYPES_FIELDS that are supported are primitive types. Note that DD_FIELDS thus contains a subset of the fields in DD_SOBJTYPES_FIELDS. Some types are primitives and some are complex types. All types controlled through the application code itself; there is no separate TYPE structure. An extremely robust set of types may be supported on top of simple types such as text, and binary objects.

An example of a more robust object type is a locator fields type. Locator field functionality is controlled by the DD_SOBJTYPE_LOCATOR_MAP structure. A locator field is basically a foreign key constraint so that one can define a field in an object relative to another object. For example, a “people” object may include a “last name” or “social security number” as one of the fields. Another object or application may also need a social security field. On another object, the “social security number” field can be defined as a locator field such that, when one enters a value in the “person” object, that information is verified against the “people” social security field. This prevents users from entering a social security number as the object that doesn't already exist in another table. This also allows automatic population of fields in applications. For example, once the person object is defined, the application can automatically populate first name, last name, social security number, etc., so that the user does not have to enter that data in manually.

The DD_SOBJTYPE_FIELDS table and DD_SOBJTYPE_LOCATOR_MAP tables are linked so if a value exists in this DD_SOBJTYPE_LOCATOR_MAP, then the two tables together constitutes a definition of what the users would ultimately interact with.

The DD_SOBJTYPE_FIELDS allows definition of every element or every attribute within the object. Once a field is defined then it can be selected and put onto a smart object. In other words, if the “first name” field doesn't exist, it can be created and put it into a business object. Within an object field definition structure (DD_SOBJTYPE_FIELDS), a number of “Anchor” fields (designated ANCHOR-$description) are provided, including anchor map ID. The anchor map ID is a key which provides a reference back to the defined object.

The anchor fields can also be considered locator fields. The SOBJTYPE_FIELDS and DD_SOBJTYPE_LOCATOR_MAP tables are connected in a logically through this data.

All fields effectively created in the DD_SOBJTYPE_FIELDS table. Subsequently, the structure SMART_OBJECT_TYPE defines the object itself. It includes the name of this object, its description, version, and other information including whether or not this is an object the system will to audit, whether or not the system would want to pull histories on it, etc. The SMART_OBJECT TYPE structure includes a primary key ID, referred to therein as the SPEC TEMPLATE ID. DD_FIELDS also provides a primary ID which is the FIELD_ID. This FIELD_ID is a unique key to get to every field in the structure. Attribute Name is also a unique key, but it's textural, not a number. Each smart object therefore has a unique ID.

Once the fields are defined,.users then pull in two sets of data to these objects. The first set is to associate fields to with the object, such as “first name,” “last name,” and other types of fields. This data is put into the DD_SOBJ TYPE_FIELDS structure which contains the object type fields. In this structure, FIELD_ID is the field that is put with this object in DD_FIELDS, and the SPEC TEMPLATE ID is the ID of the object itself. For example, if the DD_SOBJ TYPE_FIELDS had field 3, “last name” and character object 1, and included a plurality of fields 1-22, then in SMART_OBJECT_TYPE might include a table that would include a definition of object “1” having field “3,” object “1” having field “17,” object “1” having field “22,” and so on, to complete the definition of the object.

Each different object type has many different object type fields. This characterization of fields can be different for each object type, and can be overridden at display time, as discussed below. For example, even though a field may be called “last name”, one may want to call it “surname” on this object in display use. Internally, the system knows it as the “last name” field using all the rules about it, but it can be displayed as a “surname.”

The DD_SOBOBJTYPE_SECTION structure is substructure of an SMART_OBJ_TYPE. The SPEC TEMPLATE ID item in this table identifies the object in the SMART_OBJ_TYPE structure, which is the main object. The REF_SPEC_TEMPLATE_ID field holds SPEC TEMPLATE ID value of some other object. This allows one to have an embedded object; for example an object called “people” and another object called “address”, which is this simple object that has street, city, state, etc. If one defines “people” to have addresses, then in then in this table, a “1” will be the spec template ID and a “2” is the sub-category ID, which now tells the system that the object is embedded.

The TABLE_VIEW flag tells the system whether it is one or many objects. If the table view is active, the object can support many objects. The OVERRIDE flag tells the system whether it is allowed to change the object in the context of the object its embedded in, override its values in that one context, or whether it must be left it alone and make it always reference the other object. This effectively builds a hierarchy of structure that can be reconstructed back together as needed.

The DD_SOBJCTYPE_SECTION_ACTIONS structure describes the specific state transition actions that are allowed for a given object. For every action within an object, a row in this table is provided that includes things such as: what the display sequence is of that action (DISP_SEQ), and what label does one give to the display (ACTION_LABEL). In some cases, a user will require an action not part of the system. In such cases, a URL string may be provided in the URL field to allow a user to call an action residing off of the system. For example, if one wants to call a query of addresses that one has in another contact management system, the user may install URL of the particular report in this field, and that hitting that action calls the report via the URL.

Calling certain actions may affect whether other actions can proceed or not. Every time an action is invoked, a transition occurs from one state to the next. Hence a mechanism for enabling and disabling specific actions is provided. The SOBJTYPE_STTRAN_INCL_EXCL table can exclude system actions based on other actions using definitions in this table. If an action is going to invoke an automated process when, for example, a user depresses a button or hyperlink on a screen, the SOBJTYPE_STTRAN_LABELS can contain the action and identify it by a WF_TEMPLATE_ID and a WF_NAME, can directly invoke the automated method when a particular state happens. This table also allows the system to optionally invoke other workflows, and identify whether or not one should audit the fact that this happened, make a time stamp of exactly what user did this, and other auditing functions.

The ASSOCIATIONS table maintains a record of which embedded associations are allowed between objects. One cannot embed one object within another or reference one object from another unless there is an established association defined. For example, one must define that “people” can have “addresses”. The ASSOCIATIONS table tells the system the nature of each object, and why these two objects are able to talk to each other. Later, this data is used in the Layout structure to make instance connections for the objects. For example, an association might identify that a given phone number is actually on a particular person. In one example, the associations table structure has an object ID, two spec template ID's of 1 and 2, a forward string and a backward string. This identifies the cardinality of the object.

The SOBJTYPE_FAMILY structure allows users to create a particular class of object, and define the types of life cycles that particular object is allowed to have. A set of actions for a document may include, for example, the fact that the document is created when it is modified, when it is required to be modified, and whether it is checked in or checked out. Any other object that one creates can inherit and use those same actions for the object. In addition, one can allow user to create actions in groupings of state families. When one define objects in groupings, one can say this group of objects can have a specific family of actions and eliminate end users from performing illegal actions.

In a commercial embodiment, an application may include default configurations of objects. For example, in a facility center application, the system may include predefined people, building, and hardware objects. However, in accordance with the system of the present invention, users can create their own objects and program workflows using these objects without regard to a pre-defined structure limiting the type or number of objects that can be created.

Once the data dictionary is built, all of fields have been defined, objects are defined, fields have been put on the objects, objects are connected to objects and state transition are connected to those objects.

The modeling shown in FIG. 5 is exemplary as one type of definition of how objects and relations of such objects are defined. In accordance with the invention, a self-described model where all information about each object is contained within the data model allows the flexibility described above. FIG. 5 shows one implementation and one definition of how objects can be characterized.

However the invention is not limited to the particular fields, structures, objects or tables shown in FIGS. 5-7. Any mechanism of modeling the smart-object structure may be utilized. The smart object itself, when created, may be created in relational databases, XML or any other defined data model. The applications set forth above look for the model of the data, and how that data is defined.

FIG. 6 shows Layout structures used at the display level to present data to a user. A number of structures are similar to those set forth in the Data Dictionary of FIG. 5. However, the tables in FIG. 6 are read by the GUI Meta Data application 3, 4, and 5 through interaction with the user, writes out the data contained in these structures. The structures which are shared with those in FIG. 5 allow the data to be changed at display time, which does not affect the underlying data definition in the Data Dictionary. Structures having the same name in the Layout Structures generally contain the same data but can be modified during display without affecting running applications.

In the Layout structures, one is allowed to override many of the characteristics at display time that were initially described for fields at definition time. One can also provide additional fields. This table includes fields like labels, fonts, colors, and weights, and other values. Such fields have nothing to do with the definition of data but rather deal with the display of the data. For example, one still has base a base SMART_OBJ_TYPE structure. In display time, one also has a SOBJECTYPE_TABS structure which defines visual page “tabs” in a multi-tabbed structure display. Tabs have visual sections (in terms of graphical sections) within them which are defined by a SECTION TYPE. Tabs also have fields that go within a section and have fields match the sections.

The SOBJTYPE_STRUCTURE table provides for parent/child build-up capability. Objects are allowed to participate in parent/child relationships not just embedded relationships.

The SOBJTPYE_FIELD_MAP table keeps functionality relative to the header of individual records. The data in this OBJECT_FIELDS will ultimately end up being the primary data inside the application. (For Example, in FIG. 7, this is the data stored in the IBS-SPEC smart object.) The OBJECT FIELD TYPE tells one how to get to unique control numbers, for example, how to start a sequence and how to increment the sequence, and to use an image for this particular type of object and the like.

Many of the values occurring in the header record may be used for other things. For example, referring to FIG. 7, the IBS SPEC record in the Smart Object structure includes a number of fields such as QUANTITY, SPEC NAME and PRICE, etc. Were a user to desire to change the user reference of such fields, the SUB-OBJECT FIELD TYPE table presents a user with field map entries (NAME_FLD_MAP, COST_FLD_MAP, etc.) which should be used for that purpose. Some sub-set of the fields may be used as a unique key for the object. For example, one can take the first name, the last name, social security number, and the mother's name and let that be a unique identifier for a particular object. Because there may be many number fields but only one of them defines the “quantity” of this object, the system needs to know which of those fields is such “quantity.” In the prefix map, suffix map, and the control number fields, a means for tracking which object is used for what piece of data is provided.

When integrating with third party applications like Microsoft Word or Excel, or Crystal Reports, and embedding those into the object, these are embedded through the SOBJTYPE_FORMS table. This table allows labeling a name to different objects and tying them with the report form FILE_ID. One can have embedded document management forms in the template stage uploaded into a document manager, and the handle REPORT_FRM_FILE_ID is used as an internal handle to that form template in the document management process.

Each TAB (in SOBJTYPE_TABS) has a CATEGORY_ID that uniquely identifies it within this particular SPEC ID or TEMPLATE ID. Each section within SOBJTYPE_SECTION_ACTIONS contains the sections within a given tab, and the SOBJTYPE_STRUCTURE contains the fields within sections. In the application as defined in FIG. 6, any display is going to have at least a default tab of 1. It may have just one tab, in which case it generally would not be displayed. An object effectively has a set of tabs, and within a tab and it has a set of sections. Hence, there will be a display sequence on both the tabs and a display sequence on the sections within the tab. One can constitute the page and the fields themselves, and the sections allows the system to know information about the display in a page, such as a portal. For example, items such as the start row of a table, “x, y” coordinate placement of items in a display, whether or not one needs to do any graphing, whether or not one needs to automatically refresh this particular section of the portal and the refresh sequence, the time, and other information. Users, through the GUI META DATA TYPE builder 314, can also lay out application building windows (setting up tabs, setting up sections, adding fields, and getting characteristics of those fields).

The process of setting up actions, and tying actions to workflows, populates the LAYOUT tables and it gives the system the data necessary to render the application display back to the user in a format and with functions that the user desires.

This set of data ultimately gets published and shows up at the user display. Users can then start doing work with real instances of the data. The display is built to either view or input data and users can start viewing and inputting data. Initially, the structure is empty and users must input their data into the system. The process of inputting data creates SmartObjects.

Referring to FIG. 7, the structures defining an exemplary SmartObject are shown. The IBS_SPEC table is the header record that tells the system everything it needs to know about the SmartObject IBS_SPEC. The IBS SPEC VALUE is the data record for the IBS_SPEC object. There is enough information within this object that for many functions, the system does not need to retrieve actual values. The system may need values when retrieving one instance of information. However, for many of these objects, certain types of queries can be resolved at the header level. For example, a query such as “retrieve want everything of a given type within a given organization” can be resolved at the header level because organization and type are both at the header level and one can query it as though it were the actual data value. The Header is effectively a key into the SPEC VALUE.

The IBS SPEC VALUE is where the value of the records itself is stored. Other data may be kept with it besides the value such as, for example, the type of object that it is. The SPEC_ID is the instance of that object. The value record further contains the instance for the object, versioning information, and information relative to how the data is used in its primary display.

There is a SPEC_VALUE for each value a user enters. Efficiencies can therefore be created in the system by reducing the size of SPEC_VALUE.

The IBS_SPEC ASSIGNMENT table keeps two ID types from the objects that are associated, along with their type. The IBS_SPEC ASSIGNMENT table is the table where association data at the instance level is tracked. Instances of objects are connected in this table, as well what the object types are and what strings the system uses to describe that association. This table is similar to the ASSOCIATIONS table in the Data Dictionary. In the Data Dictionary, the association tells the system what an object is committed to. Its counterpart in real time is the IBS SPEC ASSIGNMENTS, defining what a type of object can have relationships with.

The SMART_SECTION ROWS and SMART OBJECT ROOT OBJECTS and SMART OBJECT INCL_EXCL are different normalizations to pull data out of SPEC_VALUE tables so that the system does not have to keep everything in a SPEC VALUE, and data can be retrieved when needed.

IBS_SPEC_VALUE_META_DATA is a table containing information about a given field in a given version. This information is stored once as meta-data as opposed to being stored with the values of those records. Since, for example, every single use of the record “last name” in the object “people” is going to have the same set of information, one can just store it once. In an alternative embodiment, some of the meta-data could stored along with the value, making the object more like an XML structure—completely self-enclosed. Although it makes the object more robust and more independent, there is cost as it causes a ballooning in the size of the data.

Hence, through these structures, the system of the present invention defines how to store the data, how to lay the data out on the screen, and how, at storage time, the data values are actually stored.

In a unique aspect, a finite number of tables define each an every object in the system. For example, the tables defining an instance of Smart Object in FIG. 7 comprise a total of 8 tables, but these eight tables hold and represent thousands of objects. In contrast to conventional system, thousands of tables are not required for various types of data. These SmartObject structures can hold people, work orders, budget codes, projects, places, addresses, buildings, furniture, etc. This set of structures tell the system everything needed to display, store, and define objects.

In effect, data in an application is flipped on its side so that for an application such as, for example, a facility management system, you don't see a building, a person, etc. You see a structure telling the system how to define a building and the characteristics that make up a building.

As noted above, one embodiment of the present invention implements a document manager application useful with respect to both a Project Management application and a Facilities Management application. Exemplary objects, and the actions associated with those objects, for a documents manager are shown in Table 1:

TABLE 1

| OBJECT | ACTION |
|---|---|
| Document | Apply; Approve; Cancel Check Out; Check In; Check Out; Delete; |
| | Discuss; Discuss Published; Download; Download Published; Final |
| | Approval; Final Delete; Ok; Publish; Reject; Rejection; Restore; Retire; |
| | Revise; Rollback Revision; Undelete; Upload; View; View Published |
| Document | Apply; Cancel Check Out; Check In; Check Out; Delete; Discuss; |
| Container | Discuss Published; Download; Download Published; Final Approval; |
| | Final Delete; Ok; Publish; Rejection; Restore; Retire; Revise; Rollback |
| | Revision; Undelete; Upload; View; View Published |
| Folder | Apply; Create; Delete; Discuss; Discuss Published; Download; |
| | Download Published; Final Delete; Ok; Undelete; View; View Published |
| Markup | Apply; Create; OK; Remove |
| Publication | Apply; Approve; Create; Delete; Discuss; Discuss Published; Download; |
| | Download Published; Final Approval; Final Delete; OK; Publish; Reject; |
| | Rejection; Restore; Retire; Revise; Rollback Revision; Undelete; View; |
| | View Published |
| ROOT | Apply; Create; Delete; Discuss; Discuss Published; Download; |
| | Download Published; Final Delete; Ok; Undelete; View; View Published |

Likewise, a facilities management application, a projects application, and any other application developed using the system of the present invention will include its own set of objects and actions. A small subset of exemplary objects and associated actions in a Facilities Management application is listed in Table 2:

TABLE 2

| Object | Actions |
|---|---|
| Building Equipment | Asset Assign - Post (Hidden); Asset Found - Post (Hidden); Asset |
| | Lost - Post (Hidden); Asset Move - In Post (Hidden); Asset Move - |
| | Out Post (Hidden); Asset Reativate - Post (Hidden); Asset Reserve - |
| | Post (Hidden); Asset Retire - Post (Hidden); Asset Return - Post |
| | (Hidden); Asset Un-Assign Post (Hidden); Asset Un-Reserve - Post |
| | (Hidden); Assign; Create; Found; Inventory Assign (Hidden); |
| | Inventory Reserve (Hidden); Inventory Unreserve (Hidden); Lost; |
| | OK; Re-activate; Receipt; Reserve; Retire; Return; Un-assign; Un- |
| | reserve |
| Software License; | Apply; Asset Assign- Post (Hidden); Asset Found - Post (Hidden); |
| | Asset Lost - Post (Hidden); Asset Move - In Post (Hidden); Asset |
| | Move - Out Post (Hidden); Asset Reativate - Post (Hidden); Asset |
| | Reserve - Post (Hidden); Asset Retire - Post (Hidden); Asset Return - |
| | Post (Hidden); Asset Un-Assign Post (Hidden); Asset Un-Reserve - |
| | Post (Hidden); Assign; Create; Found; Inventory Assign (Hidden); |
| | Inventory Reserve (Hidden); Inventory Unreserve (Hidden); Lost; |
| | OK; Re-activate; Receipt; Reserve; Retire; Return; Un-assign; Un- |
| | reserve |
| Building | Apply; Approve; Create; Get Keycuts_Hidden Ok; Publish; Re- |
| | activate; Reject; Retire; Update Parent Info; WF Clean Up; WF |
| | Rollup; WFPUPLOAD; WFRETIRE; WFSPACEAUDIT |
| Floor | Apply; Approve; Create; Get Keycuts_Hidden; Ok; Publish; Quick |
| | Add Space; Re-activate; Reject; Retire; Update Parent Info; Update |
| | Space Records; WF Clean Up; WF Rollup; WFPUPLOAD; |
| | WFRETIRE; WFSPACEAUDIT |
| Land | Apply; Approve; Create; Ok; Publish; Re-activate; Reject; Retire; |
| | Update Parent Info; WF Clean Up; WFPUPLOAD; WFRETIRE; |
| | WFSPACEAUDIT |
| Building Services | Apply; Approve; Approve (Hidden); Close Request; Create; Delete; |
| | Ok; Re-open; Reject; Reject (Hidden); Submit |
| Task | Apply; Approve; Assign; Assign Provider; Complete; Create; Create |
| | Template; Dismiss; Notification(Hidden); OK; Ok; Post; Re-Open; |
| | Reassign; Reassign Provider; Reject; Remove Template; Request |
| | Submit; Resume; Retire Template; Submit; Submit Material |
| | Request; Suspend; Unassign; WFASSIGN; WFASSIGNAUTO; |
| | WFASSIGNSOTEMP; WFASSIGNTKTEMP; WFSOTEMP; |
| | WKASSIGN; WKSUBMIT |
| Work | Apply; Approve; Assign; Assign Provider; Complete; Create; |
| Task | Dismiss; Notification(Hidden); OK; Post; Re-Open; Reassign; |
| | Reassign Provider; Reject; Request Submit; Resume; Submit; |
| | Submit Material Request; Suspend; Unassign; WFASSIGN; |
| | WFASSIGNAUTO; WFASSIGNSOTEMP; WFASSIGNTKTEMP; |
| | WFSOTEMP; WKASSIGN; WKSUBMIT |
| Work Task | Apply; Approve; Create Template; Ok; Reject; Remove Template; |
| Template | Retire Template |
| Approval Template | Apply; Create; Delete Hidden; OK |
| Facilities Project | Apply; Create; Ok; Publish; Re-activate; Retire; WFPUPLOAD; |
| Template | WFRETIRE; WFSPACEAUDIT |
| People Template | Apply; Create; OK; Remove |
| Real Estate Lease | Apply; Create; OK; Remove |
| Clause Template | |
| Real Estate Lease | Apply; Create, OK; Remove |
| Template | |
| Service Order | Apply; Copy; Create; OK; Remove; Apply |
| Template | |
| Work Template | Create; OK; Remove |
| Move | Apply; Assign; Assign Provider; Complete; Create; Dismiss; |
| Order | Notification(Hidden); OK; Post; Re-Open; Reassign; Reassign |
| | Provider; Request Submit; Resume; Submit; Suspend; Unassign; |
| | WFASSIGN; WFASSIGNAUTO; WFASSIGNSOTEMP; |
| | WFASSIGNTKTEMP; WESOTEMP; WKASSIGN; WKSUBMIT |
| Service | Apply; Apply Template; Approve; Assign; Assign Provider; |
| Order | Complete; Create; Dismiss; Notification(Hidden); OK; Post; Re- |
| | Open; Reassign; Reassign Provider; Reject; Request Submit; |
| | Resume; Submit; Suspend; Unassign; WFASSIGN; |
| | WFASSIGNAUTO; WFASSIGNSOTEMP; WFASSIGNTKTEMP; |
| | WFSOTEMP; WKASSIGN; WKSUBMIT |
| Work | Apply; Assign; Assign Provider; Complete; Create; Dismiss; |
| | Notification(Hidden); OK; Post; Re-Open; Reassign; Reassign |
| | Provider; Request Submit; Resume; Submit; Suspend; Unassign; |
| | WFASSIGN; WFASSIGNAUTO; WFASSIGNSOTEMP; |
| | WFASSIGNTKTEMP; WFSOTEMP; WKASSIGN; WKSUBMIT |

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. An application framework for creating business process management software applications, comprising:
a data store including application data and information describing said data for a runtime environment, said information including presentation information and relational information;
presentation logic outputting said data based on said information describing said data;
one or more automated business processes operable on said data.

2. The application framework of claim 1 wherein the framework includes a data dictionary including a meta-data definition of a data structure containing data values used by the system.

3. The application framework of claim 2 wherein the framework includes application code automating said one or more business process and interpreting the data dictionary to manipulate data values stored in the data structure to automate the business process.

4. The system of claim 2 further including at least one structure defining fields comprise an object.

5. The system of claim 2 further including at least one structure defining embedded relationships between objects.

6. The system of claim 2 further including at least one structure defining parent-child relationships between objects.

7. The system of claim 2 further including at least one structure defining associations between objects.

8. The system of claim 2 wherein the data store contains a plurality of data objects defined by the data dictionary.

9. The system of claim 4 wherein the data objects are combined to describe business resources.

10. The system of claim 4 further including a display layout structure definition.

11. A software application, comprising:
a plurality of business resources defined by data, and meta data contained in a data dictionary;
application code operable on said business resources to implement at least one business process and provide an output to a user.

12. The application of claim 11 wherein the meta data includes presentation information for said data.

13. The application of claim 12 wherein said business resources are constructed from a plurality of objects, said objects being defined by said meta data.

14. The application of claim 12 including at least one structure defining all fields which may comprise an object.

15. The application of claim 12 further including at least one structure defining which fields comprise an object.

16. The application of claim 12 further including at least one structure defining embedded relationships between objects.

17. The application of claim 12 further including at least one structure defining parent-child relationships between objects.

18. The application of claim 12 further including at least one structure defining associations between objects.

19. The application of claim 11 wherein said data and meta data describe a facilities management system.

20. The application of claim 19 wherein at least one object describes an element of an organization.

21. The application of claim 19 wherein at least one object describes an element of a facility.

22. The application of claim 11 wherein said data and meta data describe a project management system.

23. An application framework, comprising:
a presentation runtime;
a data store including application data objects and information describing said application data objects for a runtime environment, said information including presentation information and object relation information;
process automation code operable on said data objects implementing business processes; and
a state management engine.

24. The application framework of claim 23 wherein the process automation code includes synchronous business processes.

25. The application framework of claim 23 wherein the process automation code include asynchronous business processes.

26. A business process automation system, comprising:
a plurality of smart data objects, the data objects including a value and information about the data objects relationship to other objects, the plurality of objects defining a set of business resources;
an application presentation system, including code interpreting input to and output from the smart objects.

27. The application of claim 26 further including a work-flow engine.

28. The application of claim 26 further including a state engine updating data in respective smart objects based on transitions in the business process logic.
